(19) United States
(12) Patent Application Publication
(10) Pub. No.: US 2024/0323975 A1
(43) Pub. Date: Sep. 26, 2024

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Yanan LIN, Dongguan (CN); Jing XU, Dongguan (CN); Bin LIANG, Dongguan (CN); Yi ZHANG, Dongguan (CN)

(73) Assignee: GUANGDONG OPPO MOBILE TELECOMMUNICATIONS CORP., LTD., Dongguan (CN)

(21) Appl. No.: 18/736,473

(22) Filed: Jun. 6, 2024

Related U.S. Application Data
(63) Continuation of application No. PCT/CN2021/139275, filed on Dec. 17, 2021.

(51) Int. Cl. H04W 72/231; H04L 1/00; H04W 72/044; H04W 72/12

(52) U.S. Cl. CPC H04W 72/231; H04L 1/0003; H04W 72/044; H04W 72/12

(57) ABSTRACT

A wireless communication method, a terminal device, and a network device are provided. The wireless communication method includes: receiving, by a terminal device, first downlink control information (DCI); the first DCI is capable of scheduling a physical channel to be transmitted on N service areas, and the first DCI actually schedules a physical channel to be transmitted on M service areas; the service areas are cells or cell groups, the N service areas comprise the M service areas, and N and M are positive integers, and N≥2.

### CROSS REFERENCE TO RELATED APPLICATIONS

The present disclosure is a continuation of International Patent Application No. PCT/CN2021/139275, filed Dec. 17, 2021, the content of which is herein incorporated by reference in its entirety.

### TECHNICAL FIELD

Embodiments of the present disclosure relate to the field of communication, in particular to a wireless communication method, a terminal device, and a network device.

### RELATED ARTS

In a New Radio (NR) system, downlink control information (DCI) is capable of scheduling multiple physical downlink shared channels (PDSCHs) or physical uplink shared channels (PUSCHs). However, since the multiple PDSCHs/PUSCHs need separate scheduling information, a new DCI format is required to be introduced.

### SUMMARY

In a first aspect, a wireless communication method is provided and includes: receiving, by a terminal device, first downlink control information (DCI); the first DCI is capable of scheduling a physical channel to be transmitted on N service areas, and the first DCI actually schedules a physical channel to be transmitted on M service areas; the service areas are cells or cell groups, the N service areas include the M service areas, and N and M are positive integers, and N≥2.

In a second aspect, a terminal device is provided and includes a processor and a memory. The memory is configured to store a computer program, and the processor is configured to call and run the computer program stored in the memory to perform a method, and the method includes: receiving, by a terminal device, first downlink control information (DCI); the first DCI is capable of scheduling a physical channel to be transmitted on N service areas, and the first DCI actually schedules a physical channel to be transmitted on M service areas; the service areas are cells or cell groups, the N service areas include the M service areas, and N and M are positive integers, and N≥2.

In a third aspect, a network device is provided and includes a processor and a memory. The memory is configured to store a computer program, and the processor is configured to call and run the computer program stored in the memory to perform a method, and the method include: transmitting, by a network device, first downlink control information (DCI); the first DCI is capable of scheduling a physical channel to be transmitted on N service areas, and the first DCI actually schedule a physical channel to be transmitted on M service areas; the service areas are cells or cell groups, the N service areas comprise the M service areas, and N and M are positive integers, and N≥2.

### BRIEF DESCRIPTION OF THE DRAWINGS

FIG. 1 is a schematic diagram of a communication system architecture applied to embodiments of the present disclosure.

FIG. 2 is a schematic interaction flowchart of a wireless communication method according to some embodiments of the present disclosure.

FIG. 3 is a schematic diagram of a first information field according to some embodiments of the present disclosure.

FIG. 4 is a schematic block diagram of a terminal device according to some embodiments of the present disclosure.

FIG. 5 is a schematic block diagram of a network device according to some embodiments of the present disclosure.

FIG. 6 is a schematic block diagram of a communication device according to some embodiments of the present disclosure.

FIG. 7 is a schematic block diagram of an apparatus according to some embodiments of the present disclosure.

FIG. 8 is a schematic block diagram of a communication system according to some embodiments of the present disclosure.

### DETAILED DESCRIPTIONS

The technical solutions in embodiments of the present disclosure are described in conjunction with the drawings in the embodiments of the present disclosure. It is obvious that the described embodiments are only some embodiments of the present disclosure, and not all embodiments. All other embodiments acquired by those skilled in the art based on the embodiments in the present disclosure without the creative work are all within the scope of the present disclosure.

The technical solutions of the embodiments of the present disclosure can be applied to various communication systems, such as: a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced long term evolution (LTE-A) system, a New Radio (NR) system, an evolution system of NR system, a LTE-based access to unlicensed spectrum (LTE-U) system, a NR-based access to unlicensed spectrum (NR-U) system, a Non-Territorial Networks (NTN) system, an Universal Telecommunication System (UMTS), a Wireless Local Area Network (WLAN), an Internet of Things (IoT), a Wireless Fidelity (WiFi), a 5th Generation (5G) system or other communication systems.

Generally speaking, traditional communication systems support a limited number of connections and are easy to be implemented. However, with the development of communication technology, mobile communication systems will not only support traditional communication, but also support, for example, device to device (D2D) communication, machine to machine (M2M) communication, machine type communication (MTC), Vehicle to Vehicle (V2V) communication, and Vehicle to everything (V2X) communication, etc., embodiments of the present disclosure may also be applied to these communication systems.

In some embodiments, the communication system of the present disclosure may be applied to a carrier aggregation (CA) scenario, a dual connectivity (DC) scenario, a standalone (SA) networking scenario, or a non-standalone (NSA) networking scenario.

In some embodiments, the communication system of the present disclosure may be applied to an unlicensed spectrum considered as a shared spectrum. In some embodiments, the communication system of the present disclosure may also be applied to a licensed spectrum considered as an unshared spectrum.

In some embodiments, the communication system of the present disclosure may be applied to a FR1 frequency band (corresponding to a frequency band range of 410 MHz to 7.125 GHz), a FR2 frequency band (corresponding to a frequency band range of 24.25 GHz to 52.6 GHz), and the new frequency band, such as a high frequency band corresponding to a frequency band range of 52.6 GHz to 71 GHz or a frequency band range of 71 GHz to 114.25 GHz.

Embodiments of the present disclosure describe various embodiments in combination with a network device and a terminal device. The terminal device may also be called a user equipment (UE), an access terminal, a user unit, a user station, a mobile station, a remote station, a remote terminal, a mobile device, a user terminal, a terminal, a wireless communication device, a user agent, or a user apparatus, etc.

The terminal device may be a station (ST) in a WLAN, a cellular phone, a cordless phone, a session initiation protocol (SIP) phone, a wireless local loop (WLL) station, a personal digital assistant (PDA) device, a handheld device with wireless communication functions, a computing device, or other processing device connected to a wireless modem, a board device, a wearable device, a next-generation communication system such as a terminal device in a NR network, or a terminal device in a future evolution of public land mobile network (PLMN) network, etc.

In embodiments of the present disclosure, the terminal device may be deployed on land, including indoor or outdoor, handheld, wearable or vehicle mounted. It may be deployed on the water (such as a ship). It may be deployed in the air (such as an aircraft, a balloon, or a satellite, etc.).

In embodiments of the present disclosure, the terminal device may be a mobile phone, a tablet computer, a computer with a wireless transceiver function, a virtual reality (VR) terminal device, an augmented reality (AR) terminal device, a wireless terminal device in industrial control, self-driving, remote medical, a smart grid, transportation safety, smart city, or smart home, an on-board communication device, or a wireless communication chip/an application specific integrated circuit (ASIC)/a system on chip (SoC), etc.

As an example without limitation, in embodiments of the present disclosure, the terminal device may also be a wearable device. The wearable device may also be called a wearable smart device, which is a general name of wearable devices applying wearable technology to intelligently design daily wear, such as a glass, a glove, a watch, clothing, and a shoe, etc. The wearable device is a portable device that is directly worn on the body or integrated into the user's clothes or accessories. The wearable device is not only a hardware device, but also has powerful functions through software support, data interaction, and cloud interaction. The generalized wearable smart device has full functions, large size, complete or partial functions that may be implemented without relying on a smart phone, the generalized wearable smart device may be a smart watch or a smart glass, etc. The generalized wearable smart device may be various smart bracelets and smart jewelry for sign monitoring, which only focus on a certain application function, and needs to be configured together with other devices such as a smart phone.

In embodiments of the present disclosure, the network device may be configured to communicate with mobile devices. The network device may be an access point (AP) in a WLAN, a base station (BTS) in a GSM or a CDMA, a base station (NodeB, NB) in a WCDMA, an evolutionary base station (eNB or eNodeB) in a LTE, a relay station or access point, an on-board device, a wearable device, a network device or a base stations (gNB) in a NR network, a network device in a PLMN that will evolve in the future, or a network device in a NTN, etc. As an example without limitation, in embodiments of the present disclosure, the network device may have a mobility characteristic, for example, the network device may be a mobile device. In some embodiments, the network device may be a satellite or balloon station. For example, the satellite may be a low earth orbit (LEO) satellite, a medium earth orbit (MEO) satellite, a geostationary earth orbit (GEO) satellite, or a high elliptical orbit (HEO) satellite, etc. In some embodiments, the network device may be a base station set at land, water, or other locations.

In embodiments of the present disclosure, the network device may provide services for a cell, and the terminal device communicates with the network device through transmission resources (for example, frequency domain resources, or spectrum resources) used by the cell. The cell may be a cell corresponding to the network device (for example, a base station). The cell may belong to a macro base station or a base station corresponding to a small cell. The small cell here includes a Metro cell, a Micro cell, a Pico cell, and a Femto cell, etc. These small cells have characteristics of small coverage and low transmission power, and are suitable for providing high-speed data transmission services.

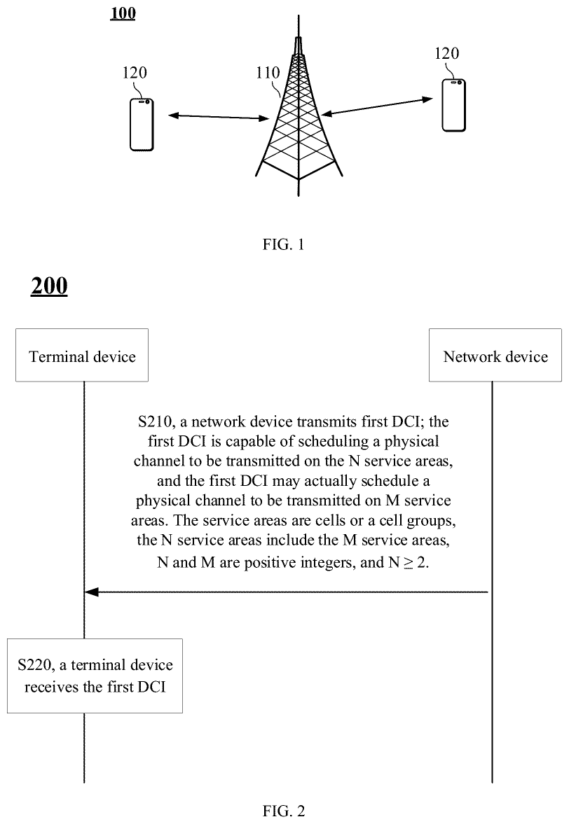

In some embodiments, a communication system 100 applied to the present disclosure is shown in FIG. 1. The communication system 100 may include a network device 110, which may be a device communicating with a terminal device 120 (or called a communication terminal, or a terminal). The network device 110 may provide communication coverage for a particular geographical area, and may communicate with terminal devices located in the coverage area.

FIG. 1 shows one network device and two terminal devices in an exemplary manner. In some embodiments, the communication system 100 may include multiple network devices, and coverage of each network device may include other number of terminal devices, which is not limited.

In some embodiments, the communication system 100 may include a network controller, a mobile management entity and other network entities, which is not limited.

It should be understood that devices with a communication function in a network/system in embodiments of the present disclosure may be called communication device. Taking the communication system 100 shown in FIG. 1 as an example, the communication device may include the network device 110 and the terminal device 120 with communication function, and the network device 110 and the terminal device 120 may be the devices described above, which will not be repeated here. The communication device may include other device in the communication system 100, such as the network controller, the mobile management entity and other network entities, which is not limited.

It should be understood that the terms “system” and “network” are often used interchangeably. The term “and/or” in embodiments of the present disclosure is only an association relationship describing the associated objects, which means that there can be three kinds of relationships; for example, A and/or B can mean three situations including: A exists alone, A and B exist simultaneously, and B exists alone. In addition, the character “/” in the present disclosure generally indicates that associated objects before and after this character are in an “or” relationship.

It should be understood that embodiments of the present disclosure involve a first communication device and the second communication device. The first communication device may be a terminal device, such as a mobile phone, a machine facility, a customer premise equipment (CPE), an industrial device, or a vehicle, etc. The second communication device may be a peer communication device of the first communication device, such as a network device, a mobile phone, an industrial device, or a vehicle, etc. In the present disclosure, the first communication device served as a terminal device and the second communication device served as a network device are described as embodiments.

The terms used in embodiments of the present disclosure are only configured to explain the embodiments of the present disclosure, and are not intended to limit the present disclosure. The terms “first”, “second”, “third”, and “fourth”, etc. in the description, claims and the drawings of the present disclosure are configured to distinguish different objects, rather than to describe a particular order. In addition, the terms “include” and “have” and any deformation thereof are intended to cover non-exclusive inclusion.

It should be understood that the “indication” mentioned in embodiments of the present disclosure may be a direct indication, an indirect indication, or an association. For example, A indicating B may mean that A indicates B directly, for example, B may be obtained through A. A indicating B may mean that A indicates B indirectly, for example, A indicates C, and B may be obtained through C; A indicating B may also mean that there is an association between A and B.

In the description of embodiments of the present disclosure, the terms “corresponding” or “correspond” may mean that there is a direct or indirect corresponding relationship between the two, or that there is an association between the two, or that there is a relationship between indicating and being indicated, or configuring and being configured.

In embodiments of the present disclosure, “predefined” or “preconfigured” may be implemented through pre-saving corresponding codes, tables or other methods that may be configured to indicate relevant information in a device (for example, including a terminal device and a network device), and embodiments of the present disclosure does not limit the implementation method. For example, the “predefined” may be defined in a protocol.

In embodiment of the present disclosure, the “protocol” may refer to the standard protocol in the communication field, for example, it may include a LTE protocol, a NR protocol, and relevant protocols applied to the future communication system, which is not limited.

In order to understand the technical solutions of embodiment of the present disclosure, the technical solutions of embodiment of the present disclosure are detailed below through some embodiments. The following related technical solutions that may be served as an optional solution may be arbitrarily combined with the technical solutions of the embodiments of the present disclosure, and the obtained all technical solutions belong to the protection scope of the present disclosure. Embodiments of the present disclosure include at least some of the following contents.

In a NR system, a physical downlink control channel (PDCCH) may carry DCI (Downlink Control Information) transmitted by a base station to a terminal device. The PDCCH may support multiple DCI formats and aggregation level sizes. A DCI format 0_0, a DCI format 0_1, and a DCI format 0_2 are configured to schedule physical uplink shared channels (PUSCHs) in a carrier/cell. A DCI format 1_0, a DCI format 1_1, and a DCI format 1_2 are configured to schedule physical downlink shared channels (PDSCHs) in a carrier/cell. Different DCI formats essentially correspond to different information sizes (such as payload sizes and bit sizes). Payload sizes of the DCI format 0_0 and the DCI format 1_0 depend on a band width of a band width part (BWP). When the bandwidth of the BWP is determined, the payload sizes of the DCI format 0_0 and the DCI format 1_0 are determined accordingly. The DCI format 0_1, the DCI format 0_2, the DCI format 1_1, and the DCI format 1_2 includes multiple configurable information fields, so that their payload sizes not only depend on the band width of the BWP, but also depend on a configuration of the base station. The DCI format 0_0 and the DCI format 1_0 have small payload sizes, highest reliabilities, but poor scheduling flexibilities, can only schedule a single transmission block (TB) for transmission, and cannot schedule large amounts of data. The DCI format 0_1 and the DCI format 1_1 have largest payload sizes and best scheduling flexibilities. The DCI format 0_2 and the DCI format 1_2 are compressed based on the DCI format 0_1 and the DCI format 1_1. Although a part of scheduling flexibility of the DCI format 0_2 and the DCI format 1_2 is lost, the payload sizes are reduced to improve transmission reliabilities.

In some embodiments, the number of different DCI payload sizes detected in each time slot may be limited to be no more than 4, and the number of different DCI payload sizes scrambled by a cell radio network temporary identity (C-RNTI) may be limited to be no more than 3. In order to meet the limit of the DCI payload size, different DCI formats are required to be padded with zero to make multiple DCI formats have the same payload size, so as to ensure that the number of total DCI payload size meets the limit.

In some embodiments, one DCI may schedule multiple PDSCHs or PUSCHs, the multiple PDSCHs/PUSCHs are transmitted in multiple carriers, each of the multiple PDSCHs/PUSCHs is configured to carry a TB which is different, and hybrid automatic repeat request acknowledgements (HARQ-ACKs) of the multiple PDSCHs are fed back on the same physical uplink control channel (PUCCH). In order to reduce a load of the DCI as much as possible, some information fields (such as modulation and coding scheme (MCS), etc.) in the DCI are shared by all PDSCHs/PUSCHs. In addition, in order to ensure a proper scheduling flexibility, some information fields (such as a new data indicator (NDI), etc.) are configured for different PDSCHs/PUSCHs separately. For a time domain resource indication, a function of a multi-PUSCH may be multiplexed. That is, a time domain resource assignment (TDRA) table may be expanded, and each row may indicate time domain resources of more than one PDSCH/PUSCH.

After one DCI is supported to schedule the multiple PDSCHs or PUSCHs, a new DCI format is required to be introduced because the multiple PDSCHs/PUSCHs need scheduling information separately. A payload of the newly introduced DCI format will be significantly greater than that of the existing DCI format. On the other hand, it is required to ensure that the number of blind detections by the terminal device remains unchanged, which means that the number of detected different DCI payload sizes that is scrambled by a C-RNTI does not exceed 3. When the existing DCI format is padded with zero to make it have the same payload as that of the newly introduced DCI format, a large amount of zero-padding information (redundant information) will be introduced, which will seriously reduce system efficiency. Therefore, after the new DCI format is configured, the terminal device may not be configured with the DCI format 1_1, the DCI format 0_1, the DCI format 1_2, and the DCI format 0_2. That is, one-to-one scheduling is configured in the existing system. Moreover, the new DCI format has good scheduling flexibility, and may schedule large amounts of data for transmission. In this case, in order to ensure a scheduling flexibility and avoid system efficiency loss, the new DCI format is required to support returning to a single PDSCH/PUSCH scheduling. Specifically, a base station may use the new DCI format to schedule a single PDSCH/PUSCH at a certain moment.

Based on the above problems, embodiments of the present disclosure design a DCI, which is configured to a schedule a physical channel to be transmitted on N cells or cell groups. The DCI may actually a schedule a physical channel to be transmitted on M cells or cell groups. That is, the DCI may flexibly schedule the physical channel to be transmitted on some cells or cell groups, thereby improving a scheduling flexibility, and avoiding a system efficiency loss.

The technical solutions of the present disclosure are detailed below through some embodiments.

FIG. 2 is a schematic flowchart of a wireless communication method 200 according to some embodiments of the present disclosure. As shown in FIG. 2, the wireless communication method 200 may include at least some of the following operations.

At operation S210, a network device transmits first DCI. The first DCI is capable of scheduling a physical channel to be transmitted on the N service areas, and the first DCI may actually schedule a physical channel to be transmitted on M service areas. The service areas are cells or a cell groups, the N service areas include the M service areas, N and M are positive integers, and N≥2.

At operation S220, a terminal device receives the first DCI.

The terminal device receives the first DCI, and the first DCI schedules the physical channel to be transmitted on the M service areas. M is a positive integer which is less than or equal to N, N is the maximum number of service areas which the first DCI is capable of scheduling for transmitting the physical channel, or N is the maximum number of service areas which the first DCI is allowed to schedule for transmitting the physical channel. “N is the maximum number of service areas which the first DCI is capable of scheduling transmitting the physical channel” may be understood that, the first DCI scheduling the physical channel to be transmitted on at most the N service areas.

In some embodiments, the physical channel includes, but is not limited to, at least one of the following: a PDSCH and a PUSCH.

It should be noted that the physical channel described in embodiments of the present disclosure may be one or more PDSCHs, one or more PUSCHs, or one or more PDSCHs, and one or more PUSCHs.

For example, the first DCI may schedule one or more PDSCHs to be transmitted on a service area in the N/M service areas. That is, one or more PDSCHs may be scheduled to be transmitted on each service area.

For another example, the first DCI may schedule one or more PUSCHs to be transmitted on the service area in the N/M service areas. That is, one or more PUSCHs may be scheduled to be transmitted on each service area.

For yet another example, the first DCI may schedule at least one PUSCH and at least one PDSCH to be transmitted on the service area in the N/M service areas. That is, at least one PUSCH and at least one PDSCH may be scheduled to be transmitted on each service area.

The M service areas may be some or all of the N service areas. That is, M≤N. In other words, the first DCI schedules the physical channel to be transmitted on at most the N service areas, and the first DCI may actually schedule the physical channel to be transmitted on the M service areas. The first DCI may flexibly schedule the physical channel to be transmitted on some or all of N service areas, thereby improving the scheduling flexibility and avoiding the system efficiency loss.

For example, in a case of M=1, a single physical channel scheduling may be returned.

In some embodiments, the first DCI is configured to schedule the physical channel to be transmitted on the N service areas. For example, a DCI format corresponding to the first DCI is a DCI format X, and the DCI format X is configured to schedule the physical channel to be transmitted on the N service areas.

For example, the network device may configure the first DCI to schedule the physical channel to be transmitted on the N service areas through a high-level signaling. The high-level signaling may be a radio resource control (RRC) signaling or a media access control control element (MAC CE).

In some embodiments, the first DCI includes a first information field, which includes N parts, and one of the N parts is configured to indicate one service area. For example, each of the N parts is configured to indicate one service area.

For example, one of the N parts is configured to indicate an identifier or a serial number of one service area.

In some embodiments, each of the N parts may be one or more fields in the first information field, or each of the N parts may be one or more bits in the first information field, or each of the N parts may be one or more sub-information fields in the first information field.

In some embodiments, the first information field may be a cell indicator field (CIF) or a cell group indicator field. In some embodiments, the first information field may be other information fields, which is not limited.

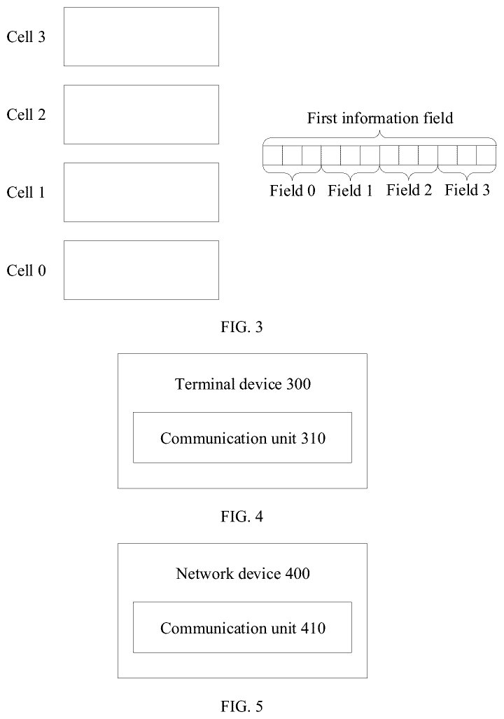

For example, as shown in FIG. 3, the first DCI is configured to schedule the physical channel to be transmitted on four cells, and the four cells are respectively marked as cells 0-3. The first information field in the first DCI includes four fields, which are respectively marked as fields 0-3, each of which includes 2 bits. In each field, values of the 2 bits are 00 representing the cell 0, 01 representing the cell 1, 10 representing the cell 2, and 11 representing the cell 3.

In some embodiments, indication results of M parts in the N parts are different. That is, indication results of N-M parts in the N parts are the same as that of one or more parts in the M parts. In other words, the indication results of the M parts in the N parts are valid. The first DCI actually schedules the physical channel to be transmitted on the M service areas.

In some embodiments, the M parts are the first M parts in the N parts.

For example, each of the N parts has a corresponding identifier, and the M parts are the first M parts ordered according to identifiers in the N parts. For example, when each of the N parts is a field or sub-information field, each part may be configured with an identifier.

For another example, the M parts are the first M parts ordered according to bits in the N parts. For example, when each of the N parts occupies k bits, the M parts occupy the first k*M bits of the k*N bits.

In some embodiments, indication results of N-M parts in the N parts are first preset values. For example, the first preset values are invalid values or reserved values. In some embodiments, the first preset values may be other values, which are not limited. That is, the indication results of N-M parts in the N parts are invalid values. In other words, the first DCI actually schedules the physical channel to be transmitted on the M service areas.

In some embodiments, the N-M parts are the last N-M parts in the N parts.

For example, each of the N parts has a corresponding identifier, and the N-M parts are the last N-M parts ordered according to identifiers. For example, when each of the N parts is a field or sub-information field, each part may be configured with an identifier.

For another example, the N-M parts are the last N-M parts ordered according to bis in the N parts. For example, when each of the N parts occupies k bits, the N-M parts occupy the last k*(N-M) bits in the k*N bits.

In some embodiments, indication results of Q parts in the N parts are the same, Q is a positive integer, Q is less than or equal to N, M=N−Q+1. That is, indication results of the M parts in the N parts are different. In other words, the indication results of the M parts in the N parts are valid. The first DCI actually schedules the physical channel to be transmitted on the M service areas.

In some embodiments, the Q parts include the last Q−1 parts in the N parts.

For example, each of the N parts has a corresponding identifier, and the Q parts include the last Q−1 parts ordered according to identifiers. For example, when each of the N parts is a field or sub-information field, each part may be configured with an identifier.

For another example, the Q parts includes the last Q−1 parts ordered according to identifiers in the N parts. For example, when each of the N parts occupies k bits, the Q parts occupy the last k*(Q−1) bits of the k*N bits.

In some embodiments, indication results of at least two parts of the N parts are the same, and the M parts include the first or last one in the at least two parts. For example, an indication result of the first one in the at least two parts is a valid value, and indication results of the other parts in the at least two parts are the same as that of the first one. For another example, an indication result of the last one in the at least two parts is a valid value, and indication results of other parts in the at least two parts are the same as that of the last one.

For example, each of the N parts has a corresponding identifier, and the at least two parts are determined parts ordered according to identifiers in the N parts. For example, when each of the N parts is a field or sub-information field, each part may be configured with an identifier.

For another example, the at least two parts are determined parts ordered according to bits in the N parts. For example, when each of the N parts occupies k bits, each part corresponds to fixed bits.

In some embodiments, the first DCI includes N1 second information fields. N1 is a positive integer, and N1 is less than or equal to N. At least one of the N parts corresponds to one of the second information fields. That is, each of the N parts corresponds to one second information field. Different parts in the N parts may correspond to a same second information field. When N1=N, each of the N parts corresponds to a separate second information field.

For example, a part ‘a’ in the N part indicates a cell ‘A’, and a second information field corresponding to the part ‘a’ is configured to indicate a parameter for which a physical channel is transmitted on the cell ‘A’.

In some embodiments, at least one of the second information fields corresponding to the M parts is configured to indicate a transmission parameter for which the physical channel is transmitted on the M service areas.

For example, the M parts include a part 1 and a part 2. The part 1 indicates a cell 1, and a second information field corresponding to the part 1 is configured to indicate a parameter for which a physical channel is transmitted on the cell 1. The part 2 indicates a cell 2, and a second information field corresponding to the part 2 is configured to indicate a parameter for which a physical channel is transmitted on the cell 2.

In some embodiments, an indication result of at least one of the second information fields corresponding to parts other than the M parts is invalid or reserved. For example, when the indication results of the M parts in the N parts are different, the indication result of the at least one of the second information fields corresponding to the parts other than the M parts is invalid or reserved.

In some embodiments, an indication result of at least one of the second information fields corresponding to the last N-M parts in the N parts is invalid or reserved. For example, when indication results of the N-M parts in the N parts are the first preset values, the indication result of the at least one of the second information fields corresponding to the last N-M parts in N parts is invalid or reserved.

In some embodiments, the first one or the last one in at least one of the second information fields corresponding to the Q parts is configured to indicate a transmission parameter for which a physical channel is transmitted on a corresponding service area. For example, the first one in the at least one of the second information fields corresponding to the Q parts is configured to indicate a transmission parameter for which the physical channel is transmitted on service areas corresponding to the Q parts. For another example, the last one in in the at least one of the second information fields corresponding to the Q parts is configured to indicate a transmission parameter for which the physical channel is transmitted on the service areas corresponding to the Q parts.

In some embodiments, an indication result of at least one of the second information fields corresponding to the last Q-1 parts in the N parts is invalid or reserved.

In some embodiments, when the indication results of the M parts in the N parts are different, at least one of the second information fields corresponding to parts other than M parts in the N parts is reconfigured to indicate first information.

In some embodiments, at least one of the second information fields corresponding to the last N-M parts in the N parts is reconfigured to indicate the first information. In some embodiments, at least one of the second information fields corresponding to the last Q−1 parts in the N parts is reconfigured to indicate the first information.

In some embodiments, the first information includes, but is not limited to, at least one of the following:
a sounding reference signal (SRS) request, a SRS resource indicator, a zero power channel state information-reference signal (ZP-CSI-RS) trigger, a phase tracking reference signal demodulation reference signal (PTRS-DMRS) association, code block group transmission information (CBGTI), code block group flushing out information (CBGFI), and a downlink assignment index (DAI).

In some embodiments, at least one of the second information fields corresponding to the parts other than the M parts in the N parts is respectively configured to indicate parameters for which physical channels are transmitted on different time domain resources in the M service areas.

In some embodiments, at least one of the second information field corresponding to the last N-M parts in the N parts is respectively configured to indicate parameters for which the physical channels are transmitted on different time domain resources in the M service areas.

In some embodiments, at least one of the second information fields corresponding to the last Q−1 parts in the N parts is respectively configured to indicate parameters of the physical channels transmitted on different time domain resources in the M service areas.

In some embodiments, information indicated by the second information fields include, but are not limited to, one of the following:
a time domain resource assignment (TDRA), a frequency domain resource assignment (FDRA), a MCS, a NDI, a redundancy version (RV), and a hybrid automatic repeat request (HARQ) process identifier.

In some embodiments, the first DCI includes N third information fields, and the N third information fields are in a one-to-one correspondence with the N service areas. Specifically, the first DCI may actually schedule physical channel to be transmitted on the M service areas through the N third information fields.

In some embodiments, each of the N third information fields occupies one bit. For example, a first value is 0 and a second value is 1; or the first value is 1 and the second value is 0.

In some embodiments, the M service areas do not include a service area corresponding to one third information field, in response to an indication result of the one third information field in the N third information fields being the first value. For example, the M service areas do not include the service area corresponding to one third information field, when an indication result of the one third information field in the N third information field sis 0.

In some embodiments, the M service areas include the service area corresponding to one third information field, in response to an indication result of the one third information field in the N third information fields being the second value. For example, the M service areas include a service area corresponding to one third information field, when the indication result of the one third information field in the N third information fields is 1.

It should be noted that the second value may be a value other than the first value, and the first value may be a value other than the second value.

In some embodiments, one third information field in the N third information fields is configured to indicate a transmission parameter for which the physical channel is transmitted on one service area. For example, each of the N third information fields is configured to indicate a transmission parameter for which the physical channel is transmitted on one service area. In some embodiments, a corresponding relationship between the N third information

fields and the N service areas is preconfigured by a network device. In some embodiments, the corresponding relationship between the N third information fields and the N service areas is agreed by a protocol. The corresponding relationship between the N third information fields and the N service areas is determined according to an ascending order or descending order of serial numbers of the N service areas.

In some embodiments, information indicated by the third information fields include, but are not limited to, one of the following:
a TDRA, a FDRA, a MCS, a NDI, a RV, and a HARQ process ID.

The technical solutions of some embodiments in the present disclosure is described in detail below through embodiments I to IV.

### Embodiment I

The first DCI may be configured to schedule the N cells or cell groups. Given N=4, and only two cells or cell groups can be scheduled at a time. That is, the CIF in the first DCI indicates at most two cells or cell groups, and the first information field (such as the CIF) in the first DCI includes two fields, which are respectively configured to indicate two cells or cell groups. This embodiment takes two cells as examples.

In the embodiment I, a first field of the two fields indicates 001 and a second field of the two fields indicates 010, which represents that a PDSCH and/or a PUSCH scheduled by the first DCI are located in a cell 1 and a cell 2 respectively. Further, second information fields corresponding to the cell 1 and the cell 2 are respectively read (separated scheduling), transmission parameters on corresponding cells are obtained, and data transmission is performed on the cell 1 and the cell 2. Alternatively, a second information field corresponding to the cell 1 and the cell 2 is read (common scheduling), the transmission parameters on the cell 1 and the cell 2 are obtained, and data transmission is performed on the cell 1 and the cell 2.

In the embodiment 1, an indication result of the first field is the same as that of the second field, such as 001, which represents that the PDSCH and/or the PUSCH scheduled by the first DCI are located in the cell 1. Further, the first DCI only schedules one PDSCH or one PUSCH located in the cell 1, or the first DCI schedules at least one PDSCH and/or PUSCH located in the cell 1. That is, the first DCI schedules at least one PDSCH and/or PUSCH transmitted on different time domain resources in the cell 1.

For example, in the common scheduling, the terminal device reads the second information field, obtains corresponding information, and performs data transmission on the cell 1. Thus, dynamic returning one-to-one scheduling is implemented.

For example, in the separated scheduling, the terminal device may perform data transmission through the following manners 1 and 2.

In the manner 1, the terminal device only reads the first (or the last) second information field, obtains corresponding information, and performs data transmission on the cell 1.

Further, in the manner 1, another second information field is reconfigured to indicate other information. For example, the second information fields are MCS information fields. The terminal device reads the first one of the MCS information fields and obtains corresponding information. The second one of the MCS information fields is no longer configured to indicate MCS information, but is configured to indicate other information. In some embodiments, the other information is applied to scheduled cells. For example, the other information may include at least one of the following: a SRS request, a SRS resource indicator, a ZP CSI-RS trigger, a PTRS-DMRS association, a CBGTI, a CBGFI, and a DAI.

That is, the dynamic returning one-to-one scheduling may be implemented based on the manner 1.

In the manner 2, the terminal device reads two second information fields. When indication results of the two second information fields are valid values, the indication results of the two second information fields are used on different time resources of the cell 1, and data transmission is performed on the cell 1. The indication results of the two second information fields are respectively configured for data transmission on different time domain resources. When only one of the indication results of two second information fields is a valid value (the other indication result is an invalid value), the indication result corresponding to the valid value is used on a time domain resource of the cell 1, and data transmission is performed on the cell 1.

The manner 2 may support dynamic switching between multi-cell scheduling, single-cell multi-slot scheduling, and one-to-one scheduling, which improves the scheduling efficiency.

In some implementations of the embodiment I, the second information fields are a FDRA 1, a TDRA 1, a HARQ process ID 1, a MCS 1, a NDI 1, a FDRA 2, a TDRA 2, a HARQ process ID 2, a MCS 2, and a NDI 2. On a time domain resource indicated by the TDRA 1, the terminal device occupies a frequency domain resource indicated by the FDRA 1, and transmits a first PDSCH or PUSCH through using a modulation and coding scheme corresponding to the MCS 1. The first PDSCH or PUSCH carries a HARQ process (of which the identifier is an indication result of the HARQ process ID 1), and an indication result of the NDI 1 represents whether the process is a new transmission. On a time domain resource indicated by the TDRA 2, the terminal device occupies a frequency domain resource indicated by the FDRA 2, and transmits a second PDSCH or PUSCH through using a modulation and coding scheme corresponding to the MCS 2. The second PDSCH or PUSCH carries a HARQ process (of which an identifier is an indication result of the HARQ process ID 2), and an indication result of the NDI 2 represents whether the process is a new transmission. When transmission directions of two physical channels are the same, that is, when both the physical channels are PDSCHs or PUSCHs, the time domain resources indicated by TDRA 2 and TDRA 1 do not overlap.

In some implementations of the embodiment I, the second information fields are a MCS 1 and a MCS 2. During two time units, the terminal device transmits the PDSCH or PUSCH through the MCS 1 and the MCS 2 respectively. A relationship between the two time units is pre-agreed or indicated by the first DCI. For example, when the first DCI indicates a first time unit in the two time units, the other one in the two time units is the first one after the first time unit, or is the first one that is capable of transmitting the PDSCH or PUSCH after the first time unit, that is, a time domain symbol occupied by the PDSCH or PUSCH is available. Specifically, for the PDSCH, the time domain symbol occupied by the PDSCH does not include an uplink symbol. For the PUSCH, the time domain symbol occupied by the PUSCH does not include a downlink symbol. In some embodiments, a time interval between the two time units is indicated by the first DCI or the high-level signaling. In some embodiments, the second information fields may be applied to FDRAs, that is, the MCSs is replaced by FDRAs.

In some implementations of the embodiment I, the second information fields are a TDRA 1 and a TDRA 2. The terminal device transmits the PDSCH or PUSCH within a time unit indicated by TDRA 1 and a time unit indicated by TDRA 2 respectively.

In some implementations of the embodiment I, the second information fields are a MCS 1 and a MCS 2. When the MCS 2 indicates 29; or when the MCS 2 indicates 29 and a NDI corresponding to the MCS2 indicates new data transmission, the terminal device determines that the indication is invalid, and the terminal device only transmit the PDSCH or PUSCH through the MCS 1 within one time unit. The one time unit may be indicated by the first DCI, for example, the one time unit may be indicated by a TDRA information field in the first DCI. In some embodiments, the one time unit may be preconfigured by the high-level signaling, for example, a time interval between the first DCI and the time unit scheduled by the first DCI is configured by the high-level signaling. The second information fields may be applied to FDRAs, for example, a FDRA 2 is set as all 0 or all 1.

### Embodiment II

The first DCI may schedule N cells at a time, and N is greater than 2. That is, N CIFs in the first DCI may indicate at most N cells. When Q indication results in indication results of the N CIFs are the same, M=N−Q+1, and Q is less than or equal to N, a processing scheme for the Q same indication results may be consistent with that in the embodiment I.

In the embodiment II, for example, N=4, Q−2, that is, M=3. An indication result of a first CIF is the same as that of a second CIF, which is 001, an indication result of a third CIF is 010, and an indication result of a fourth CIF is 011, which represents that the first DCI schedules a cell 1, a cell 3, and a cell 4. Working mechanisms of the first CIF and the second CIF are the same as that in the embodiment I.

In the embodiment II, for example, N=4, Q=3, that is, M=2. For example, the indication results of the first CIF, the second CIF, and the third CIF are the same, which are 001, and the indication result of the fourth CIF is 011, which represents that the first DCI schedule the cell 1 and the cell 4. The working mechanisms of the first CIF, the second CIF, and the third CIF are the same as that in the embodiment I.

### Embodiment III

The high-level signaling configures the first DCI to schedule the N cells or cell groups, that is, the scheduling relationship is determined semi-statically. There is no additional information field in the first DCI to explicitly indicate the cells or cell groups scheduled at this time. In the first DCI, separate third information fields are set for the N cells or cell groups. The information indicated by the third information fields include but are not limited to one of the following: a FDRA, a MCS, a TDRA, and a HARQ process ID. The N third information fields are in a one-to-one correspondence with the N cells or cell groups. The corresponding relationship may be configured by a base station, or may be determined according to an ascending order or descending order of serial numbers of the cells or cell groups.

In the embodiment III, for example, when an indication result of the i^{th} FDRA in the N FDRAs is all 0 or all 1, a cell or cell group corresponding to the i^{th} FDRA is not scheduled at this time.

In the embodiment III, for example, an indication result of the i^{th} MCS in N MCSs is 29, 30, or 31, and an indication result of a NDI corresponding to the i^{th} MCS is new transmission (that is, NDI bit flip). For new transmission data, when a coding rate cannot be obtained, the terminal device cannot obtain a size of a TB to be transmitted, transmission cannot be implemented. Thus, a cell or cell group corresponding to the i^{th} MCS is not scheduled at this time.

In the embodiment III, for example, the indication result of the i^{th} MCS in the N MCSs is 29, 30 or 31 (in this case, the terminal can only obtain a modulation order, and cannot obtain a coding rate). That is, when the first DCI is limited to schedule TB retransmission, MCS levels 29, 30 and 31 cannot be used. Thus, a cell or cell group corresponding to the i^{th} MCS is not scheduled at this time.

In the embodiment III, for example, when an indication result of the i^{th} TDRA in N TDRAs is an agreed value, a cell or cell group corresponding to the i^{th} TDRA is not scheduled at this time, and the agreed value is all 0 or all 1, or is determined based on the configuration of the base station. For example, the base station configures 16 time domain resources, and one of the time domain resources (for example, the 16^{th} time domain resource) is an invalid resource, an unavailable resource, or a reserved resource. Thus, a TDRA information field is 4 bits, which is configured to indicate one of the 16 time domain resources. When the TDRA information field indicates 1111, which corresponds to the 16^{th} resource, a corresponding cell or cell group is not scheduled at this time.

In the embodiment III, for example, when an indication result of the i^{th} HARQ process ID in N HARQ process IDs is an agreed value, such as all 1, or a value of the indication result is greater than A, and A is the maximum number of HARQ processes supported in a corresponding cell or cell group, the cell or cell group corresponding to the i^{th} HARQ process ID is not scheduled at this time. For example, the maximum number of HARQ processes supported by the cell is 8, and the cell is not scheduled when the value of the indication result is greater than 8.

In the embodiment III, an explicit cell or cell group indicator field is not added in the first DCI, but each cell or cell group has separate scheduling information. Based on the indication result of scheduling information, a function of dynamically scheduling each cell or cell group may be implemented.

### Embodiment IV

The high-level signaling configures the first DCI to schedule the N cells or cell groups, that is, the scheduling relationship is determined semi-statically. The first DCI includes N bits in a one-to-one correspondence with the N cells or cell groups. The corresponding relationship may be configured by the base station, or may be determined according to an ascending order or descending order of serial numbers of cells or cell groups. When one of the N bits is set as 0 (or 1), a corresponding cell or cell group is not scheduled at this time.

In the embodiment IV, a bitmap is used in the first DCI to indicate scheduling cells or cell groups, which may flexibly implement a function of dynamically scheduling each cell or cell group. Since all cell or cell group may share scheduling information in this case, a total overhead of the first DCI may be less than that in the embodiment II.

Therefore, in embodiments of the present disclosure, the first DCI is capable of scheduling the physical channel to be transmitted on the N service areas, and the first DCI may actually schedule the physical channel to be transmitted on the M service areas. That is, the first DCI may flexibly schedule the physical channel to be transmitted on some or all of the N service areas, thereby improving the scheduling flexibility.

Some method embodiments of the present disclosure are described in detail above combined with FIGS. 2 to 3. Some apparatus embodiments of the present disclosure are described in detail below combined with FIGS. 4 to 8. It should be understood that the apparatus embodiments and method embodiments correspond to each other, and similar descriptions may refer to the method embodiments.

FIG. 4 is a schematic block diagram of a terminal device 300 according to some embodiments of the present disclosure. As shown in FIG. 4, the terminal device 300 includes following units.

A communication unit 310 is configured to receive first DCI; the first DCI is capable of scheduling a physical channel to be transmitted on N service areas, and the first DCI actually schedules a physical channel to be transmitted on M service areas; the service areas are cells or cell groups, the N service areas include the M service areas, and N and M are positive integers, and N≥2.

In some embodiments, the first DCI includes a first information field, the first information field includes N parts, and one of the N parts is configured to indicate one service area; indication results of M parts in the N parts are different; or indication results of N-M parts in the N parts are first preset values; or indication results of Q parts in the N parts are the same, Q is a positive integer, and Q is less than or equal to N.

In some embodiments, the M parts are first M parts in the N parts; or the N-M parts are last N-M parts in the N parts; or the Q parts include last Q−1 parts in the N parts. In some embodiments, M=N−Q+1.

In some embodiments, the first DCI includes N1 second information fields, N1 is a positive integer, N1 is less than or equal to N, and one of the second information fields corresponds to at least one of the N parts; at least one of the second information fields corresponding to the M parts is configured to indicate transmission a parameter for which a physical channel is transmitted on the M service areas; or an indication result of at least one of the second information fields corresponding to parts other than the M parts is invalid or reserved; or an indication result of at least one of the second information fields corresponding to last N-M parts in the N parts is invalid or reserved; or the first one or the last one in at least one of the second information fields corresponding to the Q parts is configured to indicate a transmission parameter for which a physical channel is transmitted on a corresponding service area; or an indication result of at least one of the second information fields corresponding to the last Q−1 parts in the N parts is invalid or reserved.

In some embodiments, information indicated by each of the second information fields include one of: a time domain resource assignment (TDRA), a frequency domain resource assignment (FDRA), a modulation and coding scheme (MCS), a new data indicator (NDI), a redundancy version (RV), and a hybrid automatic repeat request (HARQ) process identifier.

In some embodiments, indication results of at least two parts of the N parts are the same, and the M parts include the first or last one in the at least two parts.

In some embodiments, the first DCI includes N third information fields, and the N third information fields are in a one-to-one correspondence with the N service areas; wherein the M service areas do not include a service area corresponding to one third information field, in response to an indication result of the one third information field in the N third information fields being a first value; or the M service areas include the service area corresponding to the one third information field, in response to the indication result of the one third information field in the N third information fields being a second value.

In some embodiments, the one third information field in the N third information fields is configured to indicate a transmission parameter for which a physical channel is transmitted on one service area.

In some embodiments, a corresponding relationship between the N third information fields and the N service areas is preconfigured by a network device or agreed by a protocol, and the corresponding relationship between the N third information fields and the N service areas is determined according to an ascending order or descending order of serial numbers of the N service areas.

In some embodiments, the physical channel includes at least one of: a physical downlink shared channel and a physical uplink shared channel.

In some embodiments, the communication unit may be a communication interface, a transceiver, or an input/output interface of a communication chip or a system on chip.

It should be understood that the terminal device 300 in embodiments of the present disclosure may correspond to the terminal device in the method embodiments of the present disclosure, and the above and other operations and/or functions of each unit in the terminal device 300 are to implement the corresponding operation of the terminal device in the method 200 shown in FIG. 2. For simplicity, the operations and/or functions are repeated here.

FIG. 5 is a schematic block diagram of a network device 400 according to some embodiments of the present disclosure. As shown in FIG. 5, the network device 400 includes: following units.

A communication unit 410 is configured to configured to transmit first DCI; the first DCI is capable of scheduling a physical channel to be transmitted on N service areas, and the first DCI actually schedule a physical channel to be transmitted on M service areas; the service areas are cells or cell groups, the N service areas include the M service areas, and N and M are positive integers, and N≥2.

In some embodiments, the first DCI includes a first information field, the first information field includes N parts, and one of the N parts is configured to indicate one service area; indication results of M parts in the N parts are different; or indication results of N-M parts in the N parts are first preset values; or indication results of Q parts in the N parts are the same, Q is a positive integer, and Q is less than or equal to N.

In some embodiments, the M parts are first M parts in the N parts; or the N-M parts are last N-M parts in the N parts; or the Q parts include last Q−1 parts in the N parts.

In some embodiments, M=N−Q+1.

In some embodiments, the first DCI includes N1 second information fields, N1 is a positive integer, N1 is less than or equal to N, and one of the second information fields corresponds to at least one of the N parts; at least one of the second information fields corresponding to the M parts is configured to indicate transmission a parameter for which a physical channel is transmitted on the M service areas; or an indication result of at least one of the second information fields corresponding to parts other than the M parts is invalid or reserved; or an indication result of at least one of the second information fields corresponding to last N-M parts in the N parts is invalid or reserved; or the first one or the last one in at least one of the second information fields corresponding to the Q parts is configured to indicate a transmission parameter for which a physical channel is transmitted on a corresponding service area; or an indication result of at least one of the second information fields corresponding to the last Q−1 parts in the N parts is invalid or reserved.

In some embodiments, information indicated by each of the second information fields include one of: a time domain resource assignment (TDRA), a frequency domain resource assignment (FDRA), a modulation and coding scheme (MCS), a new data indicator (NDI), a redundancy version (RV), and a hybrid automatic repeat request (HARQ) process identifier.

In some embodiments, indication results of at least two parts of the N parts are the same, and the M parts include the first or last one in the at least two parts.

In some embodiments, the first DCI includes N third information fields, and the N third information fields are in a one-to-one correspondence with the N service areas; wherein the M service areas do not include a service area corresponding to one third information field, in response to an indication result of the one third information field in the N third information fields being a first value; or the M service areas include the service area corresponding to the one third information field, in response to the indication result of the one third information field in the N third information fields being a second value.

In some embodiments, the one third information field in the N third information fields is configured to indicate a transmission parameter for which a physical channel is transmitted on one service area.

In some embodiments, a corresponding relationship between the N third information fields and the N service areas is preconfigured by a network device or agreed by a protocol, and the corresponding relationship between the N third information fields and the N service areas is determined according to an ascending order or descending order of serial numbers of the N service areas.

In some embodiments, the physical channel includes at least one of: a physical downlink shared channel and a physical uplink shared channel.

In some embodiments, the communication unit may be a communication interface, a transceiver, or an input/output interface of a communication chip or a system on chip.

It should be understood that the network device 400 in embodiments of the present disclosure may correspond to the network device in the method embodiments of the present disclosure, and the above and other operations and/or functions of each unit in the terminal device 300 are to implement the corresponding operation of the terminal device in the method 200 shown in FIG. 2. For simplicity, the operations and/or functions are repeated here.

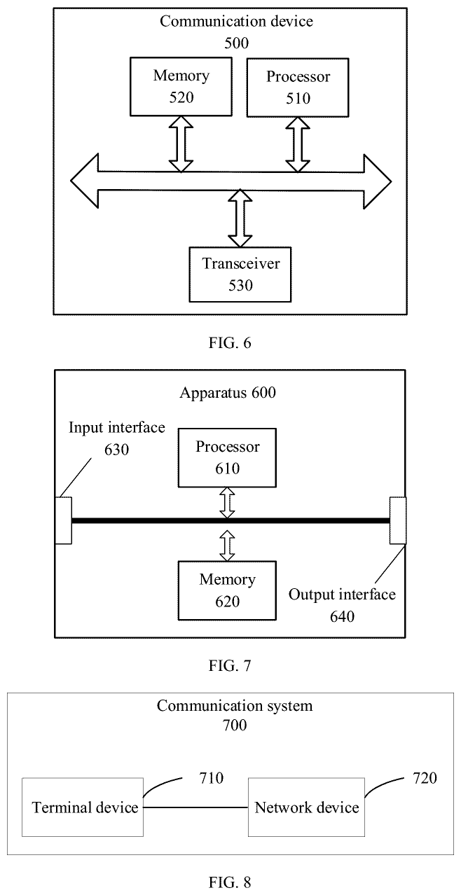

FIG. 6 is a schematic block diagram of a communication device 500 according to some embodiments of the present disclosure. The communication device 500 shown in FIG. 6 includes a processor 510, which may call and run a computer program from a memory to implement the method in the embodiments of the present disclosure.

In some embodiments, as shown in FIG. 6, the communication device 500 may include a memory 520. The processor 510 may call and run a computer program from the memory 520 to implement the method in the embodiments of the present disclosure.

The memory 520 may be a separate component independent of the processor 510, or may be integrated in the processor 510.

In some embodiments, as shown in FIG. 6, the communication device 500 may include a transceiver 530, and the processor 510 may control the transceiver 530 to communicate with other devices. In some embodiments, the processor 510 may control the transceiver 530 to transmit information or data to other devices, or receive information or data transmitted by other devices.

The transceiver 530 may include a transmitter and a receiver. The transceiver 530 may further include an antenna, the number of the antenna may be one or more.

In some embodiments, the communication device 500 may be the network device in the embodiments of the present disclosure, and the communication device 500 may implement the corresponding operations implemented by the network device in the various methods of the embodiment of the present disclosure. For simplicity, the corresponding operations are not repeated here.

In some embodiments, the communication device 500 may be the terminal device in the embodiments of the present disclosure, and the communication device 500 may implement the corresponding operations implemented by the terminal device in the various methods of the embodiment of the present disclosure. For simplicity, the corresponding operations are not repeated here.

FIG. 7 is a schematic block diagram of an apparatus according to some embodiments of the present disclosure. The apparatus 600 shown in FIG. 7 includes a processor 610, which may call and run a computer program from a memory to implement the method in the embodiments of the present disclosure.

In some embodiments, as shown in FIG. 7, the apparatus 600 may include a memory 620. The processor 610 may call and run the computer program from the memory 620 to implement the method in the embodiments of the present disclosure.

The memory 620 may be a separate component independent of the processor 610, or may be integrated in the processor 610.

In some embodiments, the apparatus 600 may include an input interface 630. The processor 610 may control the input interface 630 to communicate with other devices or chips. In some embodiments, the input interface 630 may obtain information or data transmitted by other devices or chips.

In some embodiments, the apparatus 600 may include an output interface 640. The processor 610 may control the output interface 640 to communicate with other devices or chips. In some embodiments, the output interface 640 may output information or data to other devices or chips.

In some embodiments, the apparatus may be applied to the network device in the embodiments of the present disclosure, and the apparatus may implement the corresponding operations implemented by the network device in the various methods of the embodiments of the present disclosure. For simplicity, the corresponding operations are not repeated here.

In some embodiments, the apparatus may be applied to the terminal device in the embodiments of the present disclosure, and the apparatus may implement the corresponding operations implemented by the terminal device in the various methods of the embodiments of the present disclosure. For simplicity, the corresponding operations are not repeated here.

In some embodiments, the apparatus mentioned in some embodiments of the present disclosure may be a chip. For example, the chip may be a system level chip, a system chip, a chip system, or a system chip on chip.

FIG. 8 is a schematic block diagram of a communication system 700 according to some embodiments of the present disclosure. As shown in FIG. 8, the communication system 700 includes a terminal device 710 and a network device 720.

The terminal device 710 may be configured to implement the corresponding functions implemented by the terminal device in the above methods, and the network device 720 may be configured to implement the corresponding functions implemented by the network device in the above methods. For simplicity, the corresponding functions are not repeated here.

It should be understood that the processor in some embodiments of the present disclosure may be an integrated circuit chip with a signal processing capability. In a process of implement above method, each operation of the above method embodiments may be completed by an integrated logic circuit of a hardware in the processor or instructions in a form of software. The above processors may be general purpose processors, Digital Signal Processors (DSPs), Application Specific Integrated Circuits (ASICs), Field Programmable Gate Arrays (FPGAs) or other programmable logic components, discrete gates or transistor logic components, or discrete hardware components. Each method, operation and logic block diagram disclosed in some embodiments of the present disclosure may be implemented or performed. The general processor may be a microprocessor or the processor may also be any conventional processor, etc. The operations in combination with the methods in some embodiments of the present application may be directly performed by a hardware decoding processor or the combination of a hardware and a software module in the decoding processor. The software module may be located in a random access memory, a flash memory, a read-only memory, a programmable read-only memory, or an electrically erasable programmable memory, a register, or other mature storage medium in the field. The storage medium is located in a memory, and the processor reads information in the memory and completes the operations of the above methods in combination with the hardware.

It should be understood that the memory in some embodiments of the present disclosure may be a transitory memory and/or a non-transitory memory. The non-transitory memory may be a Read-Only Memory (ROM), a Programmable ROM (PROM), an Erasable PROM (EPROM), an Electrically erasable EPROM (EEPROM) or a flash memory. The transitory memory may be a Random Access Memory (RAM), which is configured as an external cache. By a way of illustration but not limitation, many forms of RAM are available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchrolink DRAM (SLDRAM), and a Direct Rambus RAM (DR RAM). It should be noted that the memory of the systems and methods described herein is intended to include, but not limited to, these and any other suitable types of memory.

It should be understood that the above memory is example but not a limiting description. For example, the memory in some embodiments of the present disclosure may also be a SRAM, a DRAM, a SDRAM, a DDR SDRAM, an ESDRAM, a SLDRAM, and a DR RAM, etc. That is, the memory in the embodiments of the present disclosure is intended to include, but not limited to, these and any other suitable types of memory.

Some embodiments of the present disclosure provide a computer-readable storage medium configured to store a computer program.

In some embodiments, the computer-readable storage medium may be applied to the network device in the embodiments of the present disclosure, and the computer program enables a computer to perform the corresponding operations implemented by the network device in the method of the embodiments of the present disclosure. For simplicity, the corresponding operations are not repeated here.

In some embodiments, the computer-readable storage medium may be applied to the terminal device in the embodiments of the present disclosure, and the computer program enables a computer to perform the corresponding operations implemented by the terminal device in the method of the embodiments of the present disclosure. For simplicity, the corresponding operations are not repeated here.

Some embodiments of the present disclosure provide a computer program product including a computer program instruction.

In some embodiments, the computer program product may be applied to the network device in the embodiments of the present disclosure, and the computer program instruction enables a computer to perform the corresponding operation implemented by the network device in the methods of the embodiments of the present disclosure. For simplicity, the corresponding operations are not repeated here.

In some embodiments, the computer program product may be applied to the terminal device in the embodiments of the present disclosure, and the computer program instruction enables a computer to perform the corresponding operation implemented by the terminal device in the methods of the embodiments of the present disclosure. For simplicity, the corresponding operations are not repeated here.

Some embodiments of the present disclosure provide a computer program.

In some embodiments, the computer program may be applied to the network device in the embodiments of the present disclosure. When the computer program runs on a computer, it enables the computer to execute the corresponding operations implemented by the network device in the methods of the embodiments of the present disclosure. For simplicity, the corresponding operations are not repeated here.

In some embodiments, the computer program may be applied to the terminal device in the embodiments of the present disclosure. When the computer program runs on a computer, it enables the computer to execute the corresponding operations implemented by the terminal device in the methods of the embodiments of the present disclosure. For simplicity, the corresponding operations are not repeated here.

Those skilled in the art may realize that the units and algorithm operations of each example described in combination with some embodiments described herein may be implemented by an electronic hardware, or a combination of a computer software and an electronic hardware. Whether these functions are implemented in a hardware or a software depends on a specific application and design constraints of the technical solutions. A professional and technical personnel may use different methods for each specific application to implement the described functions, but such implementation should not be considered beyond the scope of the present disclosure.

Those skilled in the art may clearly understand that for convenience and conciseness of the description, a working process of the system, the apparatus, and the unit described above may refer to the corresponding operations in the above method embodiments, and are not repeated here.

In some embodiments provided herein, it should be understood that the disclosed systems, apparatuses, and methods may be implemented in other ways. For example, the device embodiments described above are merely illustrative. For example, the division of the above units is only a logical function division. In actual implementation, there may be another division manner. For example, multiple units or components may be combined or integrated into another system, or some features can be ignored or not executed. In addition, the mutual coupling or direct coupling or communication connection shown or discussed may be an indirect coupling or communication connection through some interfaces, devices or units, and may be electrical or in other forms.

The units described above as separate components may or may not be physically separated, and the components illustrated as units may or may not be physical units. The units may be located in one place, or may be distributed to multiple network units. Some or all of the units may be selected according to actual needs to achieve the purpose of a solution of the embodiments.

In addition, each functional unit in each embodiment of the present disclosure may be integrated into one processing unit, or each unit may exist physically separately. Optionally, two or more units may also be integrated into one unit. The above-described integrated unit may be stored in a computer-readable memory if

the integrated unit is implemented in the form of a software functional module and sold or used as a standalone product. Based on such understanding, the technical solution of the present disclosure, in essence or the contribution to the prior art, or all or part of the technical solution may be embodied in the form of a software product. The software product may be stored in a memory. The software product may include a number of instructions causing a computer device (the computer device may be a personal computer, a server or a network device, and the like) to perform all or parts of the operations of the above-described methods of various embodiments of the present disclosure. The foregoing memory may include various media which are able to store program codes. The media may include a U disk, a Read-Only Memory (ROM), a Random Access Memory (RAM), a removable hard disk, a magnetic disk, an optical disk, and the like.

The above description is only some embodiments of the present disclosure, but the protection scope of the present disclosure is not limited to this. Changes or replacements that are easily thought of by those skilled in the art should be covered in the protection scope of the present disclosure. Therefore, the protection scope of the present disclosure shall be subject to the protection scope of the claims.

What is claimed is:

1. A wireless communication method, comprising:
receiving, by a terminal device, first downlink control information (DCI);
wherein the first DCI is capable of scheduling a physical channel to be transmitted on N service areas, and the first DCI actually schedules a physical channel to be transmitted on M service areas;
the service areas are cells or cell groups, the N service areas comprise the M service areas, and N and M are positive integers, and N≥2.

2. The method as claimed in claim 1, wherein
the first DCI comprises a first information field, the first information field comprises N parts, and one of the N parts is configured to indicate one service area;
wherein indication results of M parts in the N parts are different; or
indication results of N-M parts in the N parts are first preset values; or
indication results of Q parts in the N parts are the same, Q is a positive integer, and Q is less than or equal to N.

3. The method as claimed in claim 2, wherein
the first DCI comprises N1 second information fields, N1 is a positive integer, N1 is less than or equal to N, and one of the second information fields corresponds to at least one of the N parts;
wherein at least one of the second information fields corresponding to the M parts is configured to indicate transmission a parameter for which a physical channel is transmitted on the M service areas; or
an indication result of at least one of the second information fields corresponding to parts other than the M parts is invalid or reserved; or
an indication result of at least one of the second information fields corresponding to last N-M parts in the N parts is invalid or reserved; or
the first one or the last one in at least one of the second information fields corresponding to the Q parts is configured to indicate a transmission parameter for which a physical channel is transmitted on a corresponding service area; or
an indication result of at least one of the second information fields corresponding to the last Q−1 parts in the N parts is invalid or reserved.

4. The method as claimed in claim 3, wherein information indicated by each of the second information fields comprise one of:
a time domain resource assignment (TDRA), a frequency domain resource assignment (FDRA), a modulation and coding scheme (MCS), a new data indicator (NDI), a redundancy version (RV), and a hybrid automatic repeat request (HARQ) process identifier.

5. The method as claimed in claim 1, wherein
the first DCI comprises N third information fields, and the N third information fields are in a one-to-one correspondence with the N service areas;
wherein the M service areas do not comprise a service area corresponding to one third information field, in response to an indication result of the one third information field in the N third information fields being a first value;
the M service areas comprise the service area corresponding to the one third information field, in response to the indication result of the one third information field in the N third information fields being a second value.

6. The method as claimed in claim 5, wherein the one third information field in the N third information fields is configured to indicate a transmission parameter for which a physical channel is transmitted on one service area.

7. The method as claimed in claim 5, wherein
a corresponding relationship between the N third information fields and the N service areas is preconfigured by a network device or agreed by a protocol, and the corresponding relationship between the N third information fields and the N service areas is determined according to an ascending order or descending order of serial numbers of the N service areas.

8. The method as claimed in claim 1, wherein the physical channel comprises at least one of: a physical downlink shared channel (PDSCH) and a physical uplink shared channel (PUSCH).

9. A terminal device, comprises a processor and a memory, wherein the memory is configured to store a computer program, and the processor is configured to call and run the computer program stored in the memory to enable the terminal device perform a method, and the method comprises:
receiving, by a terminal device, first downlink control information (DCI);
wherein the first DCI is capable of scheduling a physical channel to be transmitted on N service areas, and the first DCI actually schedules a physical channel to be transmitted on M service areas;
the service areas are cells or cell groups, the N service areas comprise the M service areas, and N and M are positive integers, and N≥2.

10. The terminal device as claimed in claim 9, wherein
the first DCI comprises a first information field, the first information field comprises N parts, and one of the N parts is configured to indicate one service area;
wherein indication results of M parts in the N parts are different; or
indication results of N-M parts in the N parts are first preset values; or
indication results of Q parts in the N parts are the same, Q is a positive integer, and Q is less than or equal to N.

11. The terminal device as claimed in claim 10, wherein
the first DCI comprises N1 second information fields, N1 is a positive integer, N1 is less than or equal to N, and one of the second information fields corresponds to at least one of the N parts;
wherein at least one of the second information fields corresponding to the M parts is configured to indicate transmission a parameter for which a physical channel is transmitted on the M service areas; or
an indication result of at least one of the second information fields corresponding to parts other than the M parts is invalid or reserved; or
an indication result of at least one of the second information fields corresponding to last N-M parts in the N parts is invalid or reserved; or
the first one or the last one in at least one of the second information fields corresponding to the Q parts is configured to indicate a transmission parameter for which a physical channel is transmitted on a corresponding service area; or
an indication result of at least one of the second information fields corresponding to the last Q−1 parts in the N parts is invalid or reserved.

12. The terminal device as claimed in claim 11, wherein information indicated by each of the second information fields comprise one of:
a time domain resource assignment (TDRA), a frequency domain resource assignment (FDRA), a modulation and coding scheme (MCS), a new data indicator (NDI), a redundancy version (RV), and a hybrid automatic repeat request (HARQ) process identifier.

13. The terminal device as claimed in claim 9, wherein
the first DCI comprises N third information fields, and the N third information fields are in a one-to-one correspondence with the N service areas;
wherein the M service areas do not comprise a service area corresponding to one third information field, in response to an indication result of the one third information field in the N third information fields being a first value;
the M service areas comprise the service area corresponding to the one third information field, in response to the indication result of the one third information field in the N third information fields being a second value.

14. The terminal device as claimed in claim 13, wherein the one third information field in the N third information fields is configured to indicate a transmission parameter for which a physical channel is transmitted on one service area.

15. The terminal device as claimed in claim 13, wherein
a corresponding relationship between the N third information fields and the N service areas is preconfigured by a network device or agreed by a protocol, and the corresponding relationship between the N third information fields and the N service areas is determined according to an ascending order or descending order of serial numbers of the N service areas.

16. The terminal device as claimed in claim 9, wherein the physical channel comprises at least one of: a physical downlink shared channel (PDSCH) and a physical uplink shared channel (PUSCH).

17. A network device, comprises a processor and a memory, wherein the memory is configured to store a computer program, and the processor is configured to call and run the computer program stored in the memory to enable the network device perform a method, and the method comprises:
transmitting, by a network device, first downlink control information (DCI);
wherein the first DCI is capable of scheduling a physical channel to be transmitted on N service areas, and the first DCI actually schedule a physical channel to be transmitted on M service areas;
the service areas are cells or cell groups, the N service areas comprise the M service areas, and N and M are positive integers, and N≥2.

18. The network device as claimed in claim 17, wherein
the first DCI comprises a first information field, the first information field comprises N parts, and one of the N parts is configured to indicate one service area;
wherein indication results of M parts in the N parts are different; or
indication results of N-M parts in the N parts are first preset values; or
indication results of Q parts in the N parts are the same, Q is a positive integer, and Q is less than or equal to N.

19. The network device as claimed in claim 18, wherein
the first DCI comprises N1 second information fields, N1 is a positive integer, N1 is less than or equal to N, and one of the second information fields corresponds to at least one of the N parts;
wherein at least one of the second information fields corresponding to the M parts is configured to indicate a transmission parameter for which a physical channel is transmitted on the M service areas; or
an indication result of at least one of the second information fields corresponding to parts other than the M parts is invalid or reserved; or
an indication result of at least one of the second information fields corresponding to last N-M parts in the N parts is invalid or reserved; or
the first one or the last one in at least one of the second information fields corresponding to the Q parts is configured to indicate a transmission parameter for which a physical channel is transmitted on a corresponding service area; or
an indication result of at least one of the second information fields corresponding to the last Q−1 parts in the N parts is invalid or reserved.

20. The network device as claimed in claim 19, wherein information indicated by each of the second information fields comprise one of:
a time domain resource assignment (TDRA), a frequency domain resource assignment (FDRA), a modulation and coding scheme (MCS), a new data indicator (NDI), a redundancy version (RV), and a hybrid automatic repeat request (HARQ) process identifier.
